(19) United States
(12) Patent Application Publication
(10) Pub. No.: US 2015/0235264 A1
(43) Pub. Date: Aug. 20, 2015

(54) AUTOMATIC ENTITY DETECTION AND PRESENTATION OF RELATED CONTENT

(71) Applicant: Google Inc., Mountain View, CA (US)

(72) Inventors: Duncan John Curtis, Castro Valley, CA (US); Alexander Ruben Stacey McCarthy, San Francisco, CA (US)

(73) Assignee: Google Inc., Mountain View, CA (US)

(21) Appl. No.: 14/182,552

(22) Filed: Feb. 18, 2014

(51) Int. Cl. G06Q 30/02; H04N 21/478; H04N 21/81; H04N 21/472; H04N 21/234; H04N 21/2668

(52) U.S. Cl. CPC G06Q 30/0255; H04N 21/23418; H04N 21/2668; H04N 21/812; H04N 21/47217; H04N 21/47815

(57) ABSTRACT

The present disclosure allows for automatic detection of an entity referenced in a video and presentation of a purchasable item associated with the identified entity to a user viewing the video. A method may include evaluating a video using one or more entity analysis techniques and identifying an entity associated with the video based on the evaluation. Next, one or more purchasable items associated with the entity may be identified. A first purchasable item may be selected from among the one or more purchasable items based on a user history associated with a user and the selected first purchasable item may be presented to the user during playback of the video.

### BACKGROUND

Videos that are produced or posted by users often include references to entities such as products, media content (e.g., music, movies, games, and applications), celebrities, etc. Users viewing these videos are more likely to be interested in purchasing the entities and/or content associated with the entities referenced in a video. Thus, it may be advantageous to detect entities referenced in a video and present items for purchase associated with the detected entities to a user viewing the video. Linking entities referenced in a video to a relevant purchasable source may help increase the number of purchases and sales associated with the entities referenced in a video.

### BRIEF SUMMARY

According to an embodiment of the disclosed subject matter a method may include evaluating a video using one or more entity analysis techniques and identifying an entity associated with the video based on the evaluation. Next, one or more purchasable items associated with the entity may be identified. A first purchasable item may be selected from among the one or more purchasable items based on a user history associated with a user and the selected first purchasable item may be presented to the user during playback of the video.

An implementation of the disclosed subject matter provides a system including a data store storing a plurality of purchasable items and a processor configured to evaluate a video using one or more entity analysis techniques. An entity associated with the video may be identified based on the evaluation. One or more purchasable items associated with the entity may be identified from among the plurality of purchasable items. From among the one or more purchasable items, a first purchasable item may be selected based on a user history associated with a user. The system may also include an output configured to present the selected first purchasable item to the user during playback of the video.

The present disclosure allows for automatic detection of an entity referenced in a video and presentation of a purchasable item associated with the identified entity to a user viewing the video. By also taking into account a user's history (e.g., purchase history, viewing history, etc.), this technique may result in presentation of highly relevant purchasable items to a user that are likely to result in the user making a purchase, which may increase the purchase of an item or content that is particularly relevant to the user. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows an example process according to an implementation of the disclosed subject matter.

FIG. 3 shows a computer according to an embodiment of the disclosed subject matter.

FIG. 4 shows a network configuration according to an embodiment of the disclosed subject matter.

### DETAILED DESCRIPTION

Videos that are produced or posted by users often include one or more references to entities such as products, media content (e.g., music, movies, games, and applications), celebrities, etc. within the content of the video. A user viewing one of these videos may be more likely to be interested in purchasing an entity and/or content associated with an entity referenced in a video while watching the video. Thus, it may be advantageous to detect an entity referenced in a video and present a purchasable item associated with the detected entity to a user during playback of the video. However, presenting a purchasable item to a viewer of the video may not result in the user making a purchase if the purchasable item is for purchasable content that the user already owns. As such, it may be valuable to compare available purchasable items related to an identified entity in a video with the user's history (e.g., purchase history, download history, etc.) and present a purchasable item that the user has not previously purchased. This technique of linking entities referenced in a video to relevant purchasable content that a user does not own may help increase the number of purchases associated with an entity referenced in a video.

Additionally, providers of purchasable items typically need to manually find individual videos that may promote their items in order to present a purchasable item relevant to a video, which can be difficult and expensive for providers of purchasable items. Currently, purchasable item providers may only make sweeping choices about whether to show purchasable items in conjunction with videos relating to their content or not, and are unable to promote the purchase of their items to particular users who may be viewing a video associated with their items. The present disclosure automatically selects a purchasable item, associated with an entity identified in video, based on a user history associated with a user and presents the purchasable item to the user. This technique may result in an increase in the purchase of items from a providers of purchasable items by automatically presenting their purchasable items to users who are likely to purchase their content.

The present disclosure provides for automatic detection of an entity associated with a video and presenting a purchasable item associated with the entity, to a user viewing the video. For example, a user, Fred, may be watching a video that was uploaded by another user. The video may be analyzed using an entity analysis technique and, as a result, an entity, i.e., the game Veggie Fighter, associated with the video may be identified. Based on the identified game Veggie Fighter, one or more purchasable items associated with the entity Veggie Fighter may be identified. For example, three purchasable items associated with the entity Veggie Fighter may be identified such as the game Veggie Fighter, a game Cake Baker by the same developer of Veggie Fighter, and a calendar featuring the characters of Veggie Fighter. A user history associated with Fred may be evaluated and it may be determined that Fred has previously purchased the games Veggie Fighter and Cake Baker. Based on the user history associated with Fred, the calendar featuring characters of Veggie Fighter may be selected. This selected purchasable item may be presented to Fred while he is watching the video.

As another example, a popular make-up blog may include a new video in which three new make-up products are reviewed. The video may be evaluated based on an entity analysis technique. As a result of the entity analysis, three different entities referenced in the video may be identified such as Brand A blush, Brand B eye shadow, and Brand C eyeliner. Next, a purchasable item associated with each of the entities may be identified. For example, a purchasable item associated with Brand A blush may be Brand A blush that is purchasable from a beauty store that sells the Brand A blush referenced in the video. A purchasable item associated with Brand B eye shadow may be a link to Brand B's website where a user may be able to purchase the Brand B eye shadow referenced in the video or other products by Brand B. A purchasable item associated with Brand C eyeliner may be a link to purchase the Brand C eyeliner from an online retailer. Based on a user history associated with the user viewing the video, it may be determined that the user has not previously purchased any of the products referenced in the video. As a result, all three purchasable items may be selected and presented to the user, while viewing the make-up review video, at the respective point in time in the video at which each of the products are referenced.

As mentioned above, user history may be used to select a purchasable item to present to a user. User history may be any information that identifies a user's purchase history, the contents of a user's media library, purchasable items that were previously presented to a user, and the like. Based on this user information, only those purchasable items for entities that a user has not previously viewed or purchased may be presented to a user. By taking into account a user's purchase history, this technique may result in presentation of purchasable items to a user that are likely to result in the user making a purchase which may result in an increase of the purchase of items and/or content that is particularly relevant to the user.

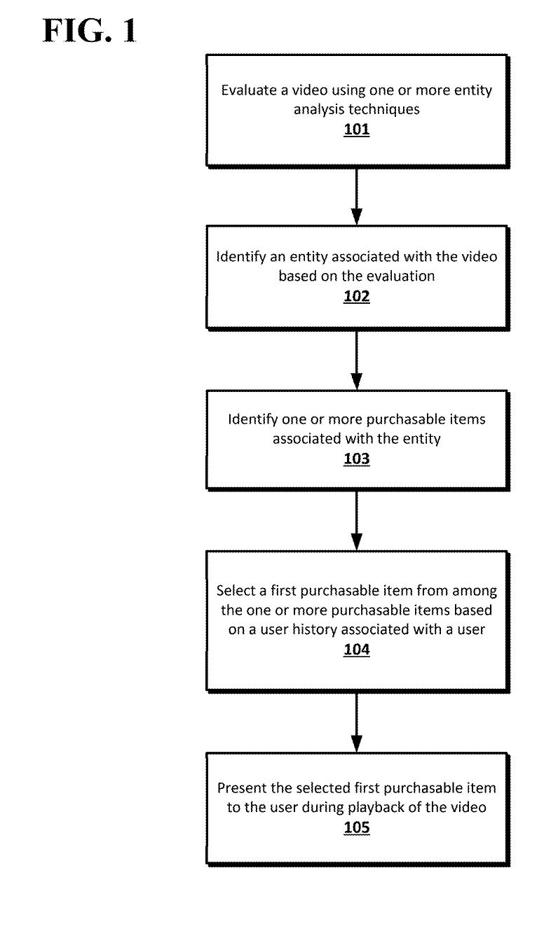

FIG. 1 shows an example process according to an implementation of the disclosed subject matter. As shown, a video may be evaluated using one or more entity analysis techniques, at 101. An entity analysis technique may be any technique that may be used to identify an entity referenced in or associated with a video. Examples of entity analysis techniques may be an audio analysis of the video, an analysis of metadata associated with the video, image analysis of one or more images in the video, and the like. Audio analysis may include an evaluation of the audio of the video to identify any entities that are referenced in the audio, such as by using voice recognition techniques. For example, the voice of a person speaking in a video may be analyzed to identify an entity that may be referenced in the video. Image analysis may include, for example, facial recognition techniques in which a computer application may automatically identify or verify the presence of an entity in a video frame from a video. One image analysis technique may be to compare features of an entity presented in the video with an entity database. Some recognition algorithms may identify features by extracting landmarks, or features, from an image of the entity in the video. For example, an algorithm may analyze the relative position, size, and/or shape of the features in an image of an entity. These features may then be used to search for an entity with matching features in an entity image database. An entity image database may include images from purchasable item providers such as online retailers, media content providers, webpages, and the like. For example, an online retailer that sells a particular vacuum may have a product page that includes a high resolution image of the vacuum. This high resolution image of the vacuum may be stored in an entity image database such that it may be used to identify a match with an image of a vacuum in a video, thereby identifying the particular vacuum as an entity in the video. Any other image analysis technique may be used to identify an image of an entity, such as a person or product that appears in the video. Metadata analysis may be an evaluation of any metadata associated with the video, metadata associated with a video may be particularly useful in identifying an entity referenced in video, where information about the contents of the video (such as transcripts of dialogue/conversations and text descriptions of its scenes) may not be directly understandable by other entity analysis techniques. Examples of metadata associated with a video may be a title of the video, user comments associated with the video, tags associated with the video, and the like, any of which may be used to identify an entity associated with the video. Another entity analysis technique may be based on a search within an entity database. For example, a database may include entity information regarding a particular video, such as time position range of 1:22:00-1:24:15 of the video features the entities Soda One, a Kevin Crawley shirt, and a Model G car (e.g., which may have been identified at some earlier step using an automated technique) and these identified entities may be used to select one or more purchasable items. Other entity analysis techniques known in the art may be used. More generally, it will be understood by one of skill in the art that any suitable entity analysis technique may be used to identify entities within a video as disclosed herein.

Referring back to FIG. 1, based on the results of the entity analysis evaluation of the video, an entity associated with the video may be identified, at 102. An entity may be any object, thing, person, place, and the like that may be associated with a video. Examples of an entity may be a media item (e.g., a book, a song, an album, a movie, a show, a video clip, a magazine, and like), a group/person (e.g., a celebrity, a personality, an author, an application developer, a music group, etc.), a character, an object, a product, a location, a business, and the like. Next, one or more purchasable items associated with the entity may be identified, at 103. A purchasable item associated with an identified entity may be the entity itself in cases in which the entity is a purchasable item, or any item for purchase associated with the identified entity. For example, an entity associated with a video may be the gaming application Veggie Fighter. Multiple purchasable items associated with the entity Veggie Fighter may be identified and may include the game Veggie Fighter (i.e., the identified entity), the game Cake Baker by the same developer of the game Veggie Fighter, an in-app purchasable item associated with the game Veggie Fighter such as a sword that may be used when playing the game, a backpack featuring a character from the game Veggie Fighter, and the like.

From among the one or more purchasable items, an purchasable item may be selected based on a user history associated with a user, at 104, and the selected purchasable item may be presented to the user during playback of the video, at 105. A purchasable item associated with an entity may be presented in any format. For example, a purchasable item may be presented using a link to a webpage, a retailer, a media provider, and any other provider of items for purchase that may be associated with the entity associated with the video. A purchasable item may also be presented in an advertisement, an interface, an action item (e.g., add to watch list, add to wish list, add to cart, etc.), an image, an audio clip, a video clip, and any other format that may be used to present a purchasable item to a user. Presentation of a selected purchasable item may be presented to a user using various techniques. A selected purchasable item may be presented in an interface, for example, placed adjacent to the video during playback or within the video during playback such as a pop-up interface within the interface in which the video may be played. As a specific example, presentation of a purchasable item may be an advertisement for a selected purchasable item associated with an entity referenced in a video.

A user history associated with a user may be based on one or multiple sources of user history associated with the user. A source of user history for a user may be any source of information regarding a user's previous activity. Examples of sources of user history associated with a user may be a media library of the user, a media viewing history of the user, a media listen history of the user from a media service provider, a purchase history of the user from one or more retailers, a webpage viewing history of the user, a conversion history of the user based on previously presented purchasable items, a purchasable item viewing history of the user, an ad selection history of the user, and the like. As an example, a user's media library may include a particular song that the user may have previously purchased. Accordingly, this information may be included in a user history associated with the user such that the same song would not be presented to the user again. According to an implementation, a list of previous purchases associated with a user may be generated based on the one or more sources of user history associated with the user. In general, a list of previous purchases may include every previous purchase made by a user identified from every available source of user history, such as purchase history from one or more retailers. User history for a user may be collected from multiple different sources, such as from a media content provider, an online retailer, an internet search provider, a video sharing site, a website, and the like. Alternatively or in addition, various techniques may be used to identify a user history associated with a user from various sources of user history such that only those purchasable items or purchasable items for items that are new to the user are presented to the user while viewing a video.

According to an implementation, a list of previously presented purchasable items associated with the user may be identified based on multiple sources of user history, and the selected purchasable item may not be in the list of previously presented purchasable items. For example, a list of previously presented purchasable items may include multiple purchasable items, such as a product A, a song B, and a movie C, all of which may have been previously presented to a user. In this case, the purchasable item that may be selected from among the one or more purchasable items based on a user history associated with the user at 104 may not be any of the purchasable items included in the list of previously presented purchasable items, i.e., the product A, the song B, and the movie C. By taking into account the purchasable items that have been previously presented to a user, only those purchasable items that may be new to the user may be presented. This may result in an increased likelihood that the user may purchase items and/or content associated with the video that the user is currently viewing.

Presentation of a selected purchasable item during playback of the video may occur at various points in time or based on events during playback of the video, for example continuous playback or paused playback. In some cases, a request may be received from the user to begin playback of the video, and a selection may be received, from the user, of a portion of the video displaying the entity. For example, a user may select (e.g. click on) a portion of the video displaying an entity indicating the user's interest in the entity. In this case, the step of identifying the entity may be performed subsequent to the step of receiving the selection from the user. As another example, playback of the video may be paused in response to receiving the selection from the user, and as a result, an entity associated with the video may be identified. The step of identifying an entity associated with the video may be performed at any time upon receiving a video from a creator such as prior to playback of the video, continuously during playback of the video, in response to a selection made by a user viewing the video, upon pausing the video in response to a selection by a user, and the like. According to an implementation, the step of identifying the entity may be performed automatically prior to beginning playback of the video. For example, when a video is received, by a video provider (e.g., a video sharing site), from the creator of the video, the video may be evaluated using one or more entity analysis techniques in order to identify one or more entities associated with the video. Following identification of an entity associated with the video, one or more purchasable items associated with the entity may be identified. Next, a request may be received from a user to play the video and in this case, a purchasable item may be selected from among the one or more identified purchasable items based on the user history associated with the user. As a result, the selected purchasable item may be presented to the user.

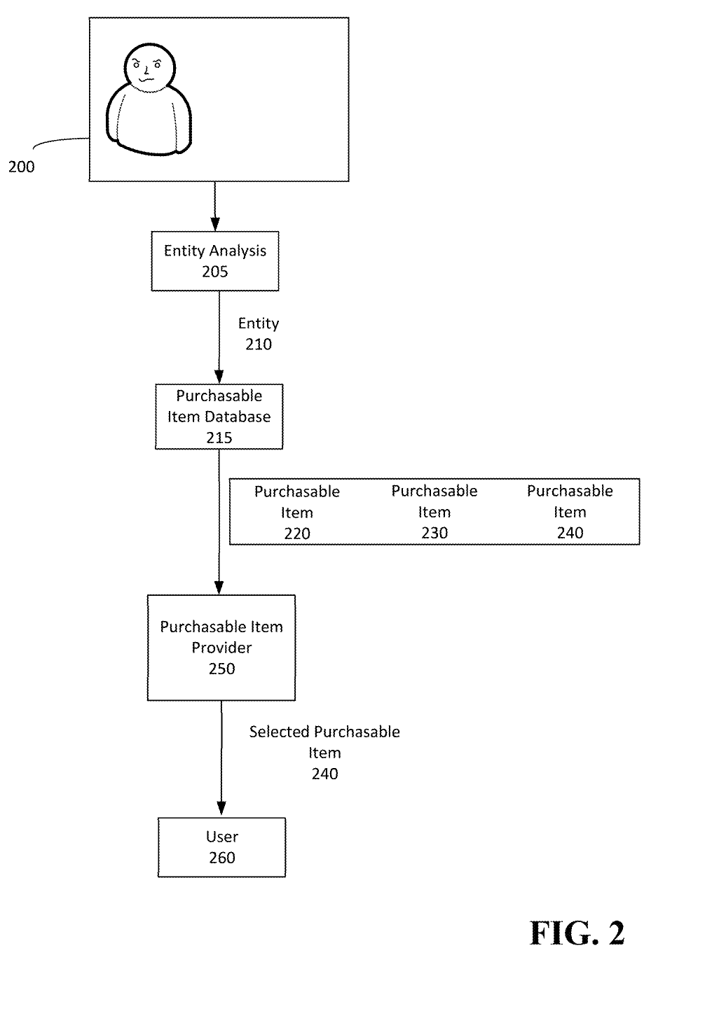

FIG. 2 shows an example process according to an implementation of the disclosed subject matter. As shown, a video 200 may show an interview on the red carpet at a movie award event. One or more entity analysis techniques 205 may be used to evaluate the video 200 to identify one or more entities associated with the video 200. At the time position 01:34 in the video 200, an entity 210 may be identified in the video 200, for example, the identified entity 210 may be the actor Brad Pitt. The identified entity Brad Pitt 210 may be used to query a purchasable item database 215 from which available items for purchase associated with the entity Brad Pitt 210 may be identified. In some cases, the purchasable item database 215 may be associated with a purchasable item provider, which may or may not be the same provider and/or host of the video 200. Based on the entity 210, three purchasable items 220, 230, and 240, each of which may be associated with Brad Pitt may be identified. For example, purchasable item 220 may be the movie Fight Club in which Brad Pitt is an actor, purchasable item 230 may be the book Brad Pitt: The Rise to Stardom, and purchasable item 240 may be a magazine featuring a recent article about Brad Pitt. A user, Cindy, may begin playing the video 200 and when playback of the video reaches the time position 01:34, one of the three purchasable items 220, 230, and 240 may be selected, by a purchasable item provider 250, based on a user history associated with Cindy. A purchasable item provider 250 may provide a selected purchasable item to the provider and/or host of the video 200, and in some cases, a purchasable item provider 250 may or may not be the provider and/or host of the video 200. For example, a purchasable item provider 250 may be a provider of a video sharing site, a provider of a video hosting site, a provider of the purchasable items database 215, and the like. As an example, the purchasable item provider 250 may determine that the user history associated with Cindy indicates that she previously purchased the movie Fight Club and that when previously presented with a magazine for purchase, she has only selected the purchasable item less than 10% of the time. Because Cindy has previously purchased the movie Fight Club, purchasable item 220 may not be selected. Similarly, because there is a very low likelihood that Cindy will select a magazine, purchasable item 240 may not be selected. Accordingly, based on the user history associated with Cindy, purchasable item 230, i.e., the book Brad Pitt: The Rise to Stardom may be selected by the purchasable item provider 250. As a result, selected purchasable item 240 may be presented to Cindy e.g., user 260 as shown, at the time position 01:34 or shortly thereafter during playback of the video 200.

Although the examples provided herein describe steps for identifying one entity in a video, selecting a purchasable item associated with the entity based on a user history, and presenting the selected purchasable item to a user, the disclosed technique may be implemented for multiple entities identified at various points in time during a video. For example, during playback of a video, an entity A may be identified at the time position 00:16 followed by the steps of identifying, selecting, and presenting a purchasable item #1 during playback of the video. Following presentation of purchasable item #1, an entity B may be identified at the time position 01:23 in the same video, and as a result, a purchasable item #2 may be identified, selected and presented to the user. Next, at the time position 02:46 in the same video, an entity C may be identified followed by the steps of identifying, selecting, and presenting a purchasable item #3 during playback of the video, and so on. In some cases, multiple entities may be identified within the same time frame in a video. For example, at or around time position 00:16, entities A and B may be identified. In this case, the entities A and B may be ranked based on the likelihood of that the user will select a purchasable item associated with each of the entities. As an example, based on a user history for a user, it may be determined that the user does not like entity A. As a result, a purchasable item associated with entity B may be selected and presented to the user at or around time position 00:16 during playback of the video. Based on the technique described herein multiple entities may be identified during the total playback time of the video and a respective selected purchasable item may be presented at the point in time in the video at which the entity is referenced.

In an implementation, communication between a video provider (e.g., a video sharing site), a purchasable item provider, and a user may be across one or more bridges between the interfaces. For example, the communications between the video provider and a user may be managed or assisted by a third device, such as, a coordinating device, a local coordinator, a remote server, etc. In such cases, the third device may, for example, evaluate a video using an entity analysis technique and/or identify an entity associated with the video and/or identify one or more purchasable items associated with the entity. The third device may then select a purchasable item based on a user history associated with the user and provide the selected purchasable item to the video provider, in which case, the video provider may present the selected purchasable item to the user. Alternatively, the third device may provide the identified entity to an purchasable item provider which may identify one or more purchasable items associated with the entity and provide the one or more purchasable items to the video provider and/or the third device, one of which may select a purchasable item from among the one or more purchasable items based on a user history. Furthermore, more than one intermediate device may be implemented to facilitate communication between a video provider (e.g., a video sharing site), a purchasable item provider, and one or more users.

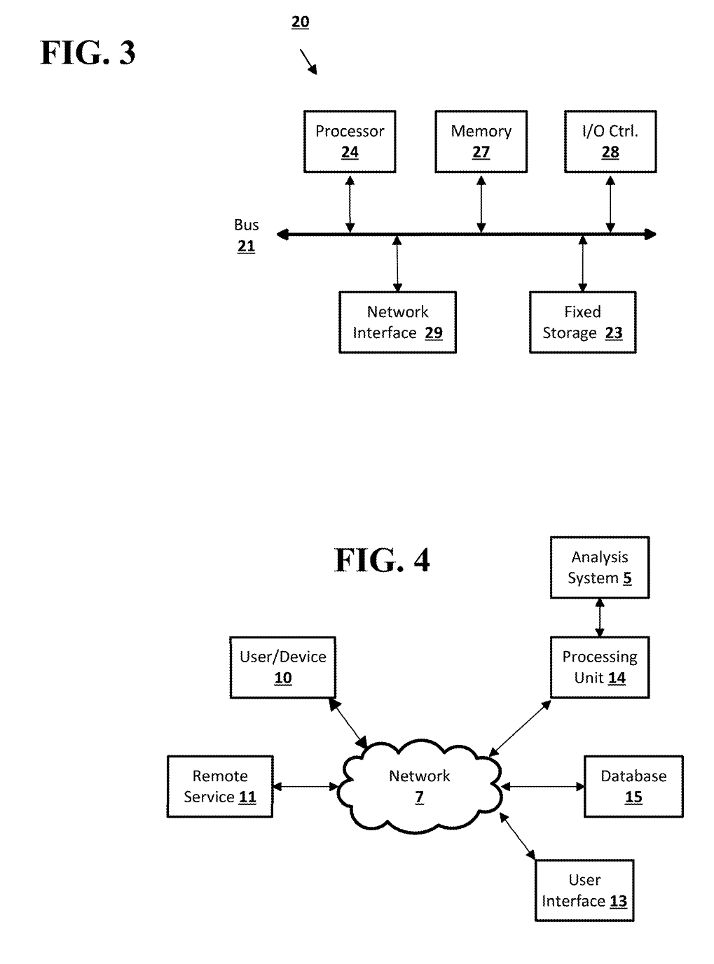

Embodiments of the presently disclosed subject matter may be implemented in and used with a variety of component and network architectures. FIG. 3 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 4.

Many other devices or components (not shown) may be connected in a similar manner, such as document scanners, digital cameras, auxiliary, supplemental, or backup systems, or the like. Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 4 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as CD-ROMs, DVDs, hard drives, USB (universal serial bus) drives, flash drives, or any other non-transitory machine readable storage medium, such that when the computer program code is loaded into and executed by a computer, the computer becomes an apparatus for practicing embodiments of the disclosed subject matter. Embodiments also may be embodied in the form of computer program code, for example, whether stored in a non-transitory storage medium, loaded into and/or executed by a computer. When the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information, as previously described. The memory or other storage medium may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
evaluating a video using one or more entity analysis techniques;
identifying an entity associated with the video based on the evaluation;
identifying one or more purchasable items associated with the entity;
selecting a first purchasable item from among the one or more purchasable items based on a user history associated with a user; and
presenting the selected first purchasable item to the user during playback of the video.

2. The method of claim 1, wherein the one or more entity analysis techniques are selected from the group consisting of: an audio analysis of the video, an analysis of metadata associated with the video, and image analysis of one or more images in the video.

3. The method of claim 1, further comprising:
receiving a request from the user to begin playback of the video; and
receiving a selection, from the user, of a portion of the video displaying the entity.

4. The method of claim 3, wherein the step of identifying the entity is performed subsequent to the step of receiving the selection from the user.

5. The method of claim 3, further comprising:
pausing playback of the video in response to receiving the selection from the user.

6. The method of claim 1, wherein the step of identifying the entity is performed prior to beginning playback of the video.

7. The method of claim 1, wherein the entity is selected from the group consisting of a media item, a person, a character, an object, a product, a location, and a business.

8. The method of claim 1, wherein the selected first purchasable item includes a link to one selected from the group consisting of: a webpage, a retailer, and a media provider.

9. The method of claim 1, wherein the user history is based on a plurality of sources of user history associated with the user.

10. The method of claim 9, further comprising identifying a list of previously presented purchasable items associated with the user based on the plurality of sources of user history; wherein the selected purchasable item is not in the list of previously presented purchasable items associated with the user.

11. The method of claim 1, wherein the user history includes at least one selected from the group consisting of: a media library of the user, a media viewing history of the user, a media listen history of the user from a media service provider, a purchase history of the user, a webpage viewing history of the user, a conversion history of the user, and an ad selection history of the user.

12. The method of claim 1, further comprising receiving a request from the user to play the video prior to selecting the first purchasable item from among the one or more purchasable items based on the user history associated with the user.

13. A system comprising:
a data store storing a plurality of purchasable items;
a processor configured to:
evaluate a video using one or more entity analysis techniques;
identify an entity associated with the video based on the evaluation;
identify one or more purchasable items associated with the entity from among the plurality of purchasable items; and
select a first purchasable item from among the one or more purchasable items based on a user history associated with a user; and
an output configured to present the selected first purchasable item to the user during playback of the video.

14. The system of claim 13, wherein the one or more entity analysis techniques are selected from the group consisting of: an audio analysis of the video, an analysis of metadata associated with the video, and image analysis of one or more images in the video.

15. The system of claim 13, wherein the processor is further configured to:
receive a request from the user to begin playback of the video; and
receive a selection, from the user, of a portion of the video displaying the entity.

16. The system of claim 15, wherein the step of identifying the entity is performed subsequent to the step of receiving the selection from the user.

17. The system of claim 15, wherein the processor is further configured to:
pause playback of the video in response to receiving the selection from the user.

18. The system of claim 13, wherein the step of identifying the entity is performed prior to beginning playback of the video.

19. The system of claim 13, wherein the entity is selected from the group consisting of a media item, a person, a character, an object, a product, a location, and a business.

20. The system of claim 13, wherein the selected first purchasable item includes a link to one selected from the group consisting of: a webpage, a retailer, and a media provider.

21. The system of claim 13, wherein the user history is based on a plurality of sources of user history associated with the user.

22. The system of claim 13, wherein the processor is further configured to identify a list of previously presented purchasable items associated with the user based on the plurality of sources of user history; wherein the selected purchasable item is not in the list of previously presented purchasable items associated with the user.

23. The system of claim 13, wherein the user history includes at least one selected from the group consisting of: a media library of the user, a media viewing history of the user, a media listen history of the user from a media service provider, a purchase history of the user, a webpage viewing history of the user, a conversion history of the user, and an ad selection history of the user.

24. The system of claim 13, wherein the processor is further configured to receive a request from the user to play the video prior to selecting the first purchasable item from among the one or more purchasable items based on the user history associated with the user.
